(19) United States
(12) Patent Application Publication
(10) Pub. No.: US 2002/0049907 A1
(43) Pub. Date: Apr. 25, 2002

(54) Permission based data exchange

(76) Inventors: Christopher E. Woods, Westport, CT (US); Barbara Danziger, Norwalk, CT (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(21) Appl. No.: 09/930,518

(22) Filed: Aug. 15, 2001

Related U.S. Application Data
(60) Provisional application No. 60/225,689, filed on Aug. 16, 2000.

(51) Int. Cl. H04L 9/00

(52) U.S. Cl. 713/182

(57) ABSTRACT

There is provided a method for a requester to gain access to desired location, for example an Internet portal or database, that requires the permission of an authority. A host receives a request for access from the requester and transmits the request to the authority. Pursuant to the authority's response, the host either provides or denies the requester with access. In one embodiment, the requester is a child and the authority is a parent or legal guardian. In another embodiment, access is granted by providing the requester with a password, URL or other access to the Internet portal. In another embodiment, the requester is an employee of a company, the desired location is a database of employees of several companies, and the access is granted by all companies providing information to the employee database.

### CROSS-REFERENCE TO RELATED PATENT APPLICATION

This application claims priority from U.S. Provisional Application Ser. No. 60/225,689 that was filed on Aug. 16, 2000. The disclosure of Ser. No. 60/225,689 is incorporated by reference in its entirety herein.

### BACKGROUND

1. Field of Invention

This invention relates to the management of private information on a computer network. More particularly, the management of proprietary personal or business private information via a third-party server.

2. Description of Related Art

Private customer and proprietary business information has become one of the most sought after commodities in the Internet marketplace. The interactive nature of the Internet is fundamentally changing the way business is done. Businesses are moving from a product-centric world to one that is customer-centric and information-centric. Businesses increasingly compete on their ability to uncover and listen to individual customers and partners and provide superior service and specifically targeted offerings. One key to succeeding in this customer-centric marketplace is the ability of a company to tailor its efforts to a specific customer.

Currently, the management of private personal and business information on the Internet is handled in a myriad of ways. Some are very open and require the user to consent while others are less obvious and collect information without the users knowledge. For example, when making a purchase on the Internet, a customer is usually required to enter in relevant information such as name, address, and method of payment. This is one example of a consensual and open exchange of information. In contrast, some parties attempt to gather personal information from an Internet user by tracking the usage of the user and generating a profile. In many cases, the tracking is done without the users knowledge or permission. If the user wishes to stop this tracking, she must “opt-out” by notifying the tracker to stop.

However, many customers would still like to receive information that is tailored to their needs while not sacrificing their privacy or being tracked without their knowledge. Providing information directly to a third party, as mentioned above, seems to satisfy these goals. This method can be inefficient though because users usually only enter data when making a purchase or registering for a service. Additionally, security concerns are usually not addressed because in many instances a user's personal data is sold or transferred to other parties. Moreover, the information provided to one party may not be appropriate for another party resulting in inaccurate user profiles. Usage tracking may be more efficient due to its constant monitoring, however it is severely crippled by its inability to effectively classify a user and most consumers react very negatively to being tracked without permission.

In addition to the above concerns, the Federal Trade Commission recently enacted the Children's Online Privacy Protection Act (COPPA) which is directed toward protecting the privacy of children on the Internet. This Act further complicates the collection of information and is indicative of a need for permission based services.

Additional concerns relating to privacy and security over networks arise in the context of industrial data sharing. Many companies rely heavily on partnerships to effectively compete in such a diverse technological marketplace. Partnerships can crumble however if information cannot be effectively shared.

There exists therefore a need for an efficient method of providing a party with accurate information of a network user while protecting the privacy of the user and the security of the data.

### SUMMARY OF THE INVENTION

Accordingly, it is an object of the invention to provide a secure method of providing accurate data to a network user about a second network user or a customer. A host receives a request for access from a requester and transmits the request to an authority. Pursuant to the authority's response, the host either provides or denies the requester with access. In one embodiment, access is granted by providing the requester with a password.

It is a feature of the invention that in one embodiment (1) the user can be a child, (2) the data can be whether the child can access a website accessible via a URL (Uniform Resource Locator), and (3) the data is provided by the parent of the child. It is a further feature of the invention that the data is stored by a trusted third party. Still further features of the invention are that the data can be customized and its transmission can be controlled by the user or in the alternative, someone in authority over the user such as a parent.

It is an advantage of the invention that a web site operator can efficiently obtain the consent of a parent to provide information to a child and to collect information from that child. It is a further advantage that personal or private information about an Internet user can be transmitted to a third party with the permission of the provider of the information.

In accordance with one embodiment of the invention there is provided a method of providing permission to a web site to transmit data to a child. A web site accessible via a URL receives a request for access from a child. The site then transmits the request to an authority database. The authority database receives the request and transmits a response from the site to either (1) grant, or (2) deny access to the child.

In accordance with a second aspect of the invention there is provided a method of creating and maintaining a vendor account on behalf of an individual entity through the use of a third-party server accessible via the Internet. An individual registers personal information with a Permission Based Information Exchange (PCIX) server and a cookie is stored on the individual's computer. The individual visits a PCIX registered vendor's web site and the web site accesses the cookie to identify the individual as a PCIX customer. If the vendor wishes to access customer information it can send a request to the PCIX server. The PCIX server would then notify the individual that a request has been made by this vendor and ask for authorization to send the information. The individual can then respond to the request and, without limitation, (1) have the information transmitted to the vendor; (2) have specific information transmitted to the vendor; or (3) have no information transmitted to the vendor.

It is a feature of the invention that a PCIX meta-directory can be created to allow different entities to map their information to all vendors. The meta-directory maps all information to create a single point of contact for web vendors. Vendors will only need to sign up with the directory to access all third-party services.

It is an advantage of the invention that users who register their personal information can “opt-in” to sharing their personal information only with those sites which the user authorizes.

In accordance with a third embodiment of the invention there is provided a permission based method for providing an individual from one organization with information about an individual from a partner organization. At least a first partner and a second partner provide employee information to a PCIX server. The PCIX server creates a matrix of the two sets of employee information and input the matrix into a meta-directory. Based on a request for information from the meta-directory, the requester is provided with a response that is dynamically mapped from the matrix and other subsets of the meta-directory. The partner companies could pre-authorize some or all of the transmission of data to requesters or in the alternative, require authorization on a case by case basis.

In one aspect of this embodiment, two or more companies contribute salesperson information to a PCIX server. The PCIX server compiles a matrix of the information and inputs that information into a meta-directory that could links salespeople across each company based on a desired function or capability. One such match could be where two salespeople from different companies both sell their respective service to a common customer. The meta-directory would also store communications between the salespeople and track any referrals.

Additionally, the PCIX server can be programmed to handle requests for information in different ways. One example would be to prompt a requester for additional information and allow the sender or receiver to route requests to additional infomediaries. It would also be possible to attach additional content to these communications.

It is a feature of the invention that individual companies can require requests to conform to a predetermined form and if deficient, either deny access to the information or request more information from the requester.

It is an advantage of the invention that an employee in one organization can rapidly locate the appropriate employee in a partner company. It is a further advantage of the invention that the PCIX meta-directory structure provides a secure and reliable third-party authorization platform. It is a further advantage of the invention that the PCIX meta-directory structure enables a specific method of communicating information between parties and while adding that information to the meta-directory.

### BRIEF DESCRIPTION OF THE DRAWINGS

FIG. 1 illustrates a generic authorization.

FIG. 2 illustrates a child request authorization.

FIG. 3 displays a child's subscription.

FIG. 4 illustrates in flow chart format an example of a PCIX transaction.

FIG. 5 illustrates a multi-company PCIX transaction.

### DETAILED DESCRIPTION

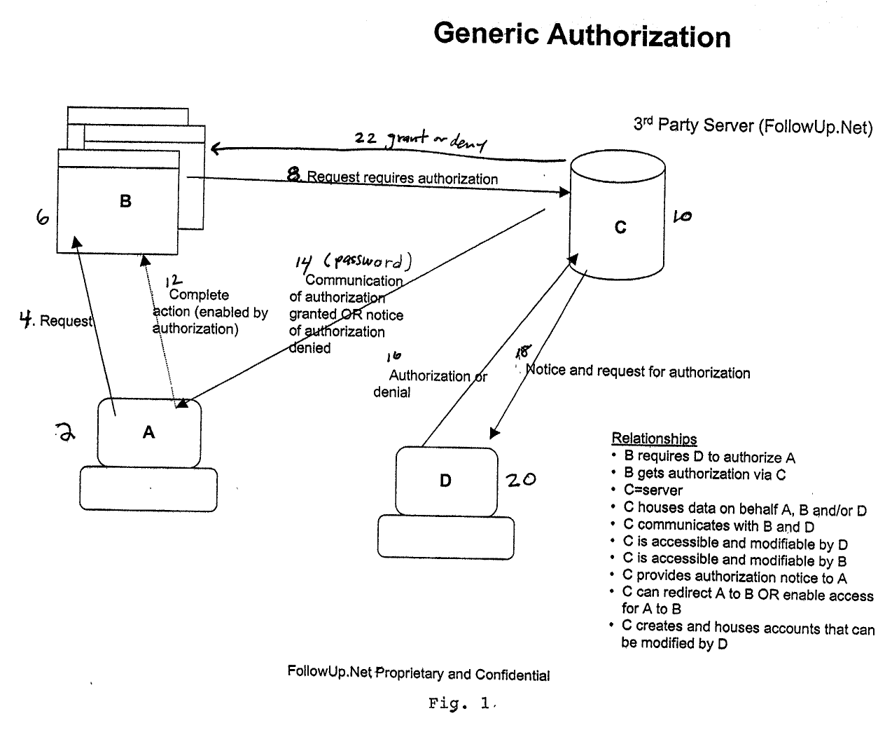

With reference to FIG. 1 a requester 2 requests 4 information from a host 6. Host 6 receives request 4 and transmits 8 request 4 to authority database server 10. Database authority 10 communicates 18 request 4 to authorization party 20. Authorization party 20 communicates 16 authorization or denial to database authority 10. If authorization is communicated, database authority transmits either (1) a signal 22 to host 6 to provide information or (2) a signal 14 to requester 2 which includes a key, such as a password, to access the requested information from host 6. If authorization is denied, database authority 10 transmits a signal 22′ to host 6 to withhold information or a signal 14′ to requester 2 indicating that access is forbidden.

In an alternative embodiment, authorization party 20 provides a list of authorized and unauthorized locations to database authority 10. Database authority 10 stores this list and responds to host 6 request 8 based on the list without contacting authorization party 20.

Host 6 and servers outlined in other embodiments are typically a computer, more specifically a web server, located on the Internet or within a network of computers such as a Local Area Network (LAN) or a Wide Area Network (WAN). Host 6 and database server 10 server are typically connected to the Internet or the computer network via high-speed connections such as a T1 line. Requester 2 locates host 6 via an Internet Protocol (IP) address or other computer network address assigned to host 6. Requester 6 can have a fixed IP address on the network or be a user who is dynamically assigned an IP address when logged in to the network. Database authority 10 is also a computer located on the computer network and is also assigned an IP address or other network address. Authority 20 is accessible via the computer network and communication between the parties is typically accomplished via Transmission Control Protocol/Internet Protocol (TCP/IP) and can be encrypted into cypher text. Common encryption schemes utilize 128 binary digit (bit) encryption but greater or lesser encryption schemes can be used. Other communication methods effective to transmit data over a computer network are equally appropriate.

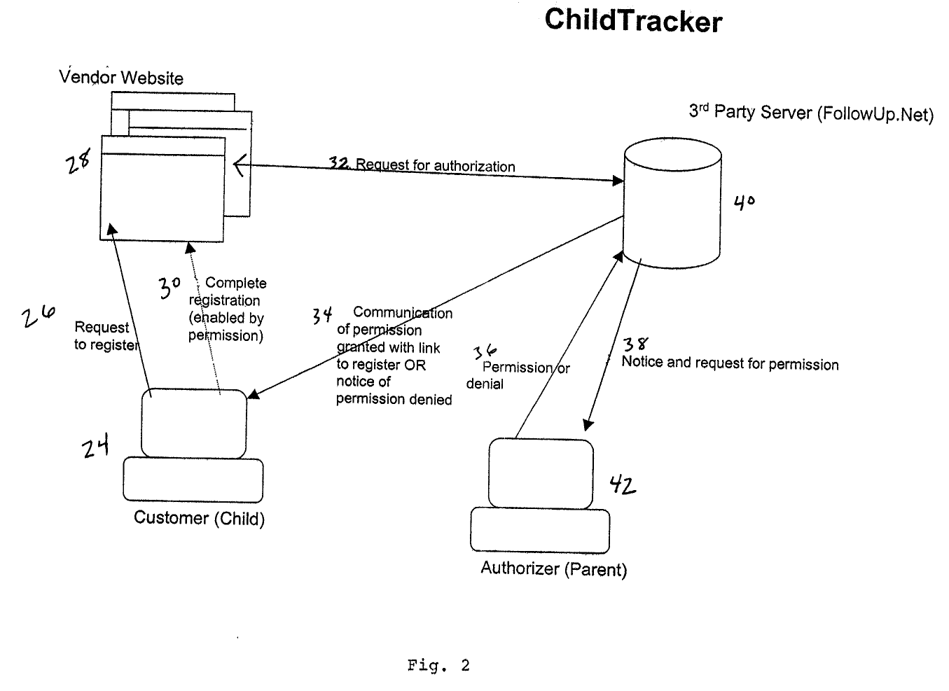

With reference to FIG. 2, a child 24 accesses 26 a vendor website 28 and requests to register. Vendor website 28 transmits 32 request to a third-party server 40 such as followup.net. Third-party server 40 notifies 38 parent 42 of child 24 that child 24 wishes to register at vendor website 28. Parent 42 then transmits 36 a grant or denial of permission to third party server 40. If parent 42 grants permission, third-party server 40 communicates 32 to vendor 28 that child is permitted to register and or sends a key 34 such as a password to child 24 to register at vendor website 28. If parent 42 denies permission, server 40 notifies vendor website 28 that child cannot register and or notifies 34 child 24 that he or she cannot register.

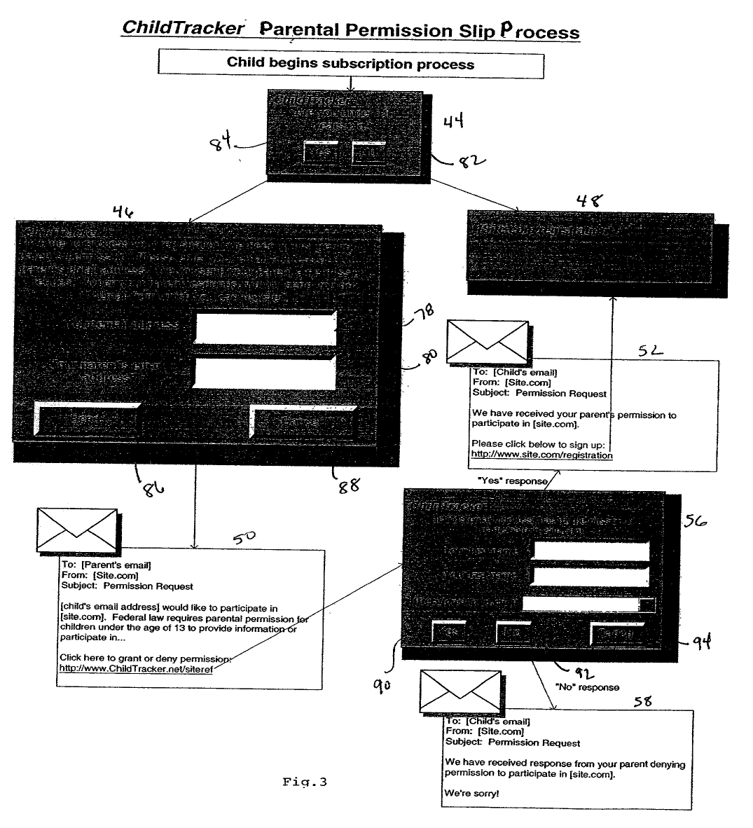

FIG. 3 is a graphical illustration of a subscription process for a child to gain access to information or send information to a web site. A first pop up question box 44 is displayed when a user attemps to gain access to information that requires parental permission if the user is under the age of 13 or to send personal information. Selecting “no” button 82 allows the user to access the requested information or to send personal information to the site. Selecting “yes” button 84 launches a second pop up box 46. Second pop up box 46 prompts the user for his or her e-mail address 78 and the e-mail address of the child's parent 80. After filling in these the child selects send button 86 to continue or cancel button 88 to cancel the transaction. If the child selects send button 86, an e-mail 50 is sent to the parent notifying it that the child would like to access information on the site or send information to the site. The parent can then fill out a third pop up box 56 filling in without limitation (1) the parent's name and (2) the relationship to the child if not the parent. By selecting the yes button 90, the child would be granted permission via e-mail 52 to access the site or send information to the site 48. By selecting no button 92, the child would be notified via e-mail 58 that permission to access the information or send information is forbidden. Selecting cancel button 94 would also result in the authorization being denied by no action.

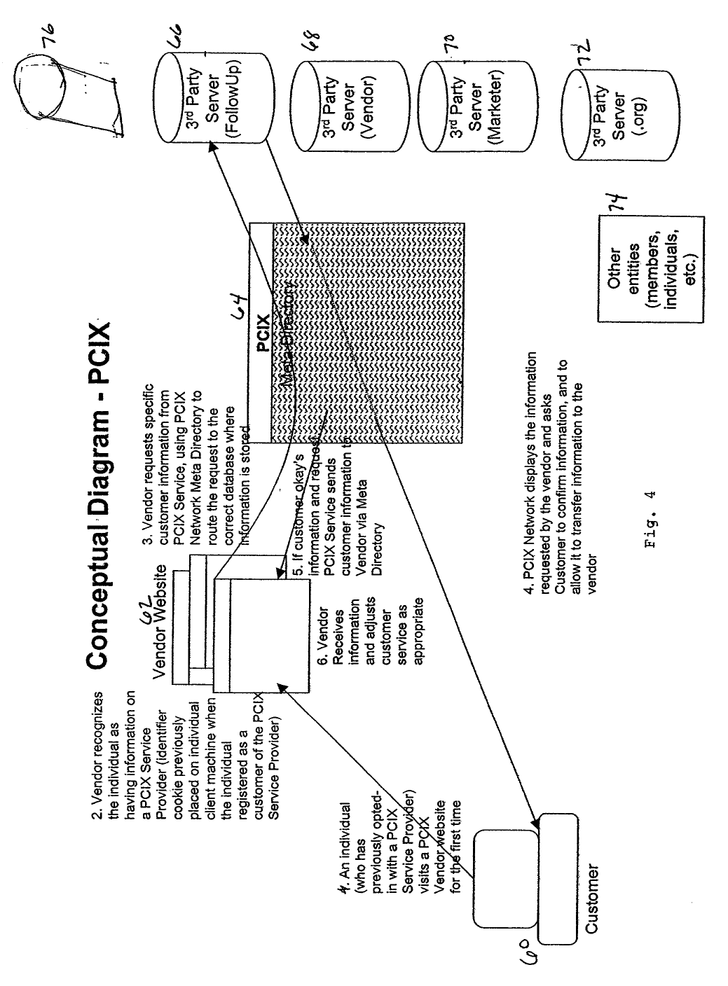

FIG. 4 is a graphical illustration in flow chart format of a PCIX transaction. A customer 60 registers personal information without limitation, (1) name, (2) address, (3) credit card information, (4) age, (5) occupation, (6) salary, (7) marital status, (8) number and ages of children, (9) brand preferences, (10) purchasing habits, (11) medical history, (12) delivery instructions, (13) contact information, and (14) travel preferences with a PCIX server 66. PCIX server 66 creates a profile of customer 60 and stores it in a PCIX meta directory 64 and transmits a cookie to customer's 60 computer. Customer 60 accesses a vendor's 62 web site and the vendor is alerted by the PCIX cookie that customer 60 is a PCIX member. Vendor 62 can then request personal information located in the PCIX meta directory 64 from PCIX server 66 about customer 60. The PCIX server notifies customer 60 that an information request has been sent from vendor 62 and customer 60 can then decide whether to allow the PCIX server to transmit the requested information to vendor 62.

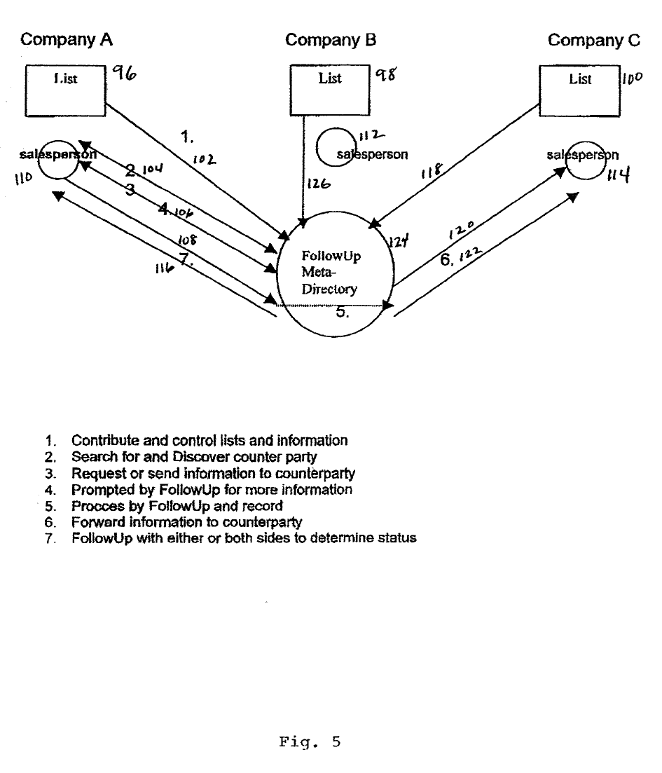

FIG. 5 is an illustration of a multi-company matrix and meta-directory system. Companies 96, 98 and 100 transmit an employee characteristic list including without limitation (1) employee name, (2) employee position, (3) sales territory, (4) current customers, and (5) prospective customers to a third-party meta-directory 124. Meta-directory 124 compiles a matrix listing that relates employees from one company to employees of at least a second company by common position, customer, territory or other relevant variable. A salesperson 110 could access meta-directory 124 to find a suitable partner from at least a second company. Companies 96, 98, and 100 would have full control over the transmission of the information it provided. In another embodiment, companies 96, 98, and 100 would pre-authorize the transmission of information.

It is apparent that there has been provided a method for a requester to gain access to desired location that fully satisfies the objects, means and advantages set forth hereinbefore. While the invention has been described in combination with specific embodiments and examples thereof, it is evident that many alternatives, modifications and variations will be apparent to those skilled in the art in light of the foregoing description. Accordingly, it is intended to embrace all such alternatives, modifications and variations as fall within the spirit and broad scope of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A method for a requester to gain access to a desired location requiring the permission of an authority, comprising the steps of:
providing a host to receive a request for access from said requester and to transmit said request to said authority;
said host receiving a response from said authority; and
dependent on said response, said host either providing said requester with access to said desired location or denying said requester access to said desired location.

2. The method of claim 1 wherein said host is a computer server interconnected to said requester and to said authority.

3. The method of claim 2 wherein said desired location is a data base accessible by a uniform resource listing (URL).

4. The method of claim 3 wherein said host is interconnected to said requester and to said authority by an integrated network of computers.

5. The method of claim 4 wherein said integrated network of computers is an Internet.

6. The method of claim 4 wherein said access is in the form of a password.

7. The method of claim 4 wherein said access is in the form of a URL portal to said desired location.

8. The method of claim 4 wherein said requester is a child under the age of 18 and said authority is a parent or legal guardian of said child.

9. The method of claim 8 wherein said child is under the age of 13.

10. The method of claim 8 wherein said host further provides said authority with a list of desired locations accessed by said requester.

11. The method of claim 10 wherein said authority has the capability via said host of denying said requester with further access to one or more of said desired locations on said list of desired locations.

12. The method of claim 8 wherein responsive to said request for access, said host obtains said requester's age and if said age is less than 13, said host obtains an identity of said authority from said requester and then notifies said authority of said request for access, wherein responsive to a response from said authority, said host either grants or denies said requester said desired access.

13. The method of claim 12 wherein said step of notifying said authority includes one or more of a name of said desired location, information collected about said requester by said desired location, a privacy statement of said desired location, whether information collected by said desired location is shared with others and credit card validation information.

14. A method for a host to provide known data about an entity to a third party pursuant to said entity's authorization, comprising the steps of:
providing a means for said third party to recognize said entity as a member of a service of said host;
responsive to said recognition, said host receiving a request from said third party for specific information about said entity;
said host surveying at least one data repository for said specific information about said entity;
said host displaying said specific information about said entity to said entity and requesting authorization from said entity to provide at least a portion of said specific information to said third party; and
responsive to an opting in of said entity, said host providing at least a portion of said specific information to said third party.

15. The method of claim 14 wherein said host, said entity and said third party are interconnected via an integrated network of computers.

16. The method of claim 15 wherein said third party is provided with an indication that said entity is a member of said service of said host via digitally transmitted data.

17. The method of claim 16 wherein said digitally transmitted data is a cookie embedded with in said entity's computer's memory.

18. The method of claim 16 wherein said specific information is located on a plurality on non-related data bases.

19. The method of claim 18 wherein not one of said non-related data bases contains all of said specific information.

20. The method of claim 18 wherein said host further classifies said specific information into a plurality of categories and said entity may opt to provide information classified within one or more of said plurality of categories.

21. The method of claim 20 wherein said categories are selected from the group including permission and privacy information, contact information, descriptive information, preference information and account information.

22. The method of claim 21 wherein said host further provides services selected from the group consisting of managing and editing permission levels, tracks subscriptions to email letters and notifications, enters and edits personal profile information and client or business information, records and up-dates delivery information and controls and monitors email and access provided to children.

23. The method of claim 14 wherein said third party conforms to conditions of said host prior to being granted access to any of said specific information.

24. The method of claim 23 wherein said conditions of said host include responsible use of personal information.

25. The method of claim 2 wherein said desired location is a meta-directory containing at least two data sets originating from two or more providers of said at least two data sets.

26. The method of claim 25 wherein said data sets are lists of employee information.

27. The method of claim 26 wherein said meta-directory is accessible only with permission of said providers.

28. A method for a creating a meta-directory containing at least two data sets originating from two or more providers of said at least two data sets, comprising the steps of:
providing a host to receive said at least two sets of data;
said host receiving at least a first of said data set from a first authority and at least a second data set from a second authority;
responsive to said reception of said first and second data sets, said host compiling a matrix that is a first subset of said meta-directory;
said host receiving a request for access to said matrix from a requester; and
said host determining first if said requester is authorized by each of said authorities to access said matrix and second, allowing access only if said requester is authorized by each of said authorities.

29. The method of claim 27 wherein if said requester is not authorized by each of said authorities, said host transmits a request for authorization to each of said authorities.

30. The method of claim 28 wherein if any of said authorities denies authorization, said requester is denied access to said matrix.

31. The method of claim 29 wherein a second subset of said meta-directory is the communications between individuals using said meta-directory.
